(19) United States
(12) Patent Application Publication
(10) Pub. No.: US 2026/0258822 A1
(43) Pub. Date: Sep. 3, 2026

(54) DIRECTIONAL CONTROL VALVE

(71) Applicant: KAWASAKI JUKOGYO KABUSHIKI KAISHA, Kobe-shi, Hyogo (JP)

(72) Inventors: Masahiro OHIRA, Kobe-shi (JP); Yoshiyuki TODE, Kobe-shi (JP); Hiroki OSHIMA, Kobe-shi (JP)

(73) Assignee: KAWASAKI JUKOGYO KABUSHIKI KAISHA, Kobe-shi, Hyogo (JP)

(21) Appl. No.: 18/846,870

(22) PCT Filed: Mar. 13, 2023
(86) PCT No.: PCT/JP2023/009720

§ 371 Date: Sep. 13, 2024

(30) Foreign Application Priority Data
Mar. 28, 2022 (JP) 2022-051498

(51) Int. Cl. F15B 13/04

(52) U.S. Cl. CPC F15B 13/0402

(57) ABSTRACT

A directional control valve includes: a housing including a spool hole, a pump passage, a tank passage, and a pair of supply/discharge passages; and a spool received in the spool hole. The spool blocks the supply/discharge passages from the pump passage and the tank passage when the spool is in its neutral position, and brings one of the supply/discharge passages into communication with the pump passage and the other one of the supply/discharge passages into communication with the tank passage when the spool shifts from the neutral position. An opening area between the pump passage and the one of the supply/discharge passages increases to a maximum value while a stroke of the spool is increasing to a predetermined value, and falls below the maximum value when the stroke of the spool exceeds the predetermined value.

### TECHNICAL FIELD

The present disclosure relates to a directional control valve installed in a hydraulic circuit.

### BACKGROUND ART

Conventionally, a directional control valve to switch the moving direction of a bi-directional hydraulic actuator (e.g., a double-acting cylinder or a hydraulic motor) has been known. The directional control valve includes: a housing including a spool hole; and a spool received in the spool hole.

In a hydraulic circuit including hydraulic actuators, there is a case where directional control valves are connected to a pump in parallel with each other. In such a hydraulic circuit, in the case of performing a combined operation to move multiple hydraulic actuators concurrently, in order to restrict the amount of hydraulic liquid supplied to a particular hydraulic actuator, a priority valve serving as a variable restrictor may be installed upstream of the directional control valve that corresponds to the particular hydraulic actuator (see Patent Literature, for example).

### CITATION LIST

### Patent Literature

PTL 1: Japanese Laid-Open Patent Application Publication No. H08-302751

### SUMMARY OF INVENTION

### Technical Problem

Regarding the above combined operation, there is a desire to restrict the amount of hydraulic liquid supplied to the particular hydraulic actuator without using the priority valve.

In view of the above, an object of the present disclosure is to provide a directional control valve that makes it possible to restrict the amount of hydraulic liquid supplied to a particular hydraulic actuator without using a priority valve.

### Solution to Problem

The present disclosure provides a directional control valve including: a housing including a spool hole, a pump passage, a tank passage, and a pair of supply/discharge passages; and a spool that blocks the pair of supply/discharge passages from the pump passage and the tank passage when the spool is in its neutral position, and brings one of the pair of supply/discharge passages into communication with the pump passage and the other one of the pair of supply/discharge passages into communication with the tank passage when the spool shifts from the neutral position, the spool being received in the spool hole. An opening area between the pump passage and the one of the pair of supply/discharge passages increases to a maximum value while a stroke of the spool is increasing to a predetermined value, and falls below the maximum value when the stroke of the spool exceeds the predetermined value.

### Advantageous Effects of Invention

The present disclosure provides a directional control valve that makes it possible to restrict the amount of hydraulic liquid supplied to a particular hydraulic actuator without using a priority valve.

### BRIEF DESCRIPTION OF DRAWINGS

FIG. 1 shows a hydraulic circuit including a directional control valve according to one embodiment.

FIG. 2 is a graph showing a relationship between a spool stroke and an opening area in the directional control valve.

FIG. 3 is a partial sectional view of the directional control valve, showing a state where the spool is in its neutral position.

FIG. 4 is a partial sectional view of the directional control valve, showing a state where the spool stroke is a predetermined value.

FIG. 5 is a partial sectional view of the directional control valve, showing a state where the spool stroke is maximized.

### DESCRIPTION OF EMBODIMENTS

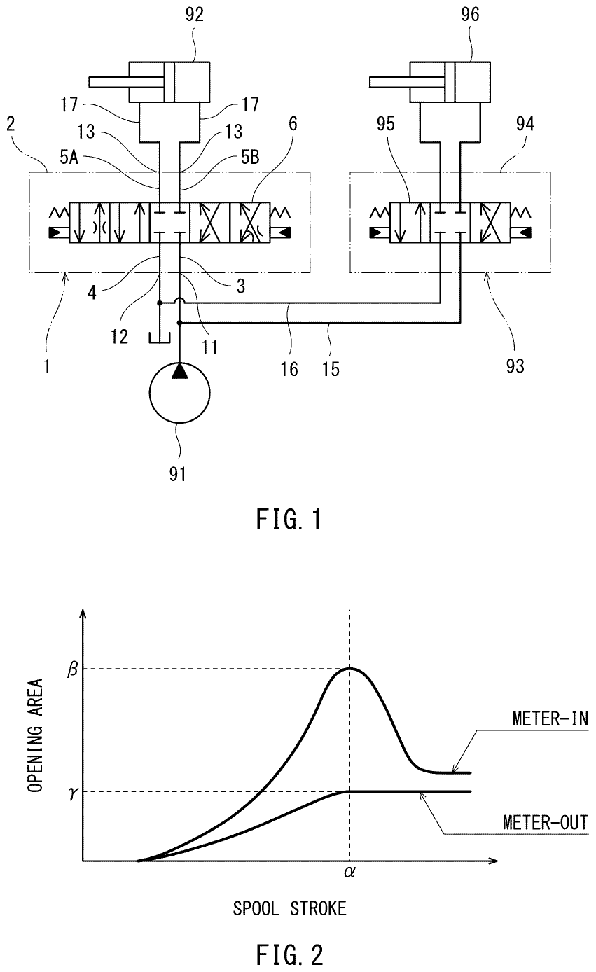

FIG. 1 shows a hydraulic circuit including a directional control valve 1 according to one embodiment. The hydraulic circuit further includes another directional control valve 93.

The directional control valve 1 is a valve to switch the moving direction of a hydraulic actuator 92, which moves bi-directionally. The directional control valve 93 is a valve to switch the moving direction of a hydraulic actuator 96, which moves bi-directionally. For example, each of the hydraulic actuators 92 and 96 is a double-acting cylinder or a hydraulic motor.

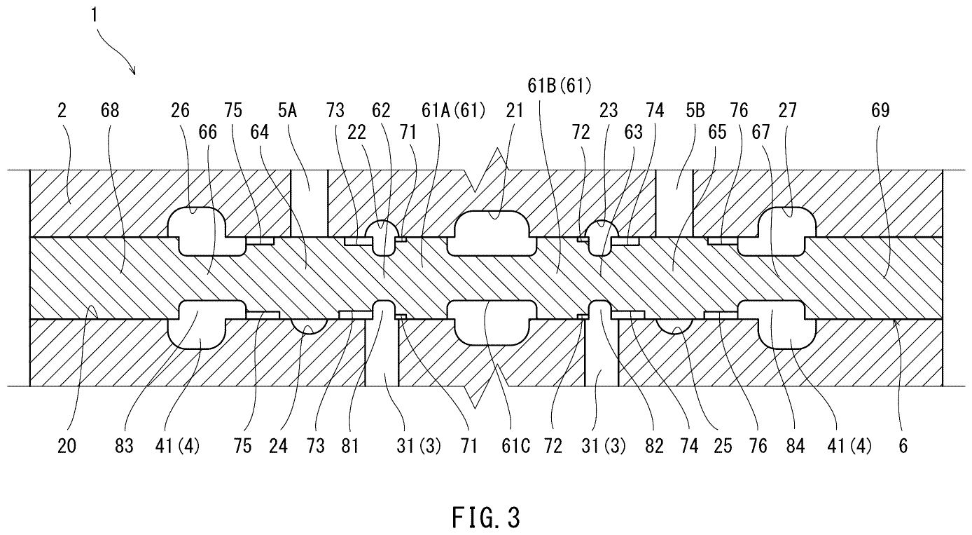

The directional control valve 1 includes: a housing 2 including a spool hole 20 (see FIG. 3); and a spool 6 received in the spool hole 20. Similarly, the directional control valve 93 includes: a housing 94 including a spool hole; and a spool 95 received in the spool hole. The housings 2 and 94 of the respective directional control valves 1 and 93 may be integrated together.

The directional control valve 1 is connected to a pump 91 by a supply line 15 in parallel with the directional control valve 93, and is connected to a tank by a tank line 16 in parallel with the directional control valve 93. The directional control valve 1 is further connected to the hydraulic actuator 92 by a pair of supply/discharge lines 17.

In addition to the spool hole 20, the housing 2 includes a pump passage 3, a tank passage 4, and a pair of supply/discharge passages 5A and 5B. The pump passage 3 forms a pump port 11 at the surface of the housing 2, and the supply line 15 is connected to the pump port 11. The tank passage 4 forms a tank port 12 at the surface of the housing 2, and the tank line 16 is connected to the tank port 12. The supply/discharge passages 5A and 5B form supply/discharge ports 13, respectively, at the surface of the housing 2, and the supply/discharge lines 17 are connected to the supply/discharge ports 13, respectively.

In a case where the housings 2 and 94 of the respective directional control valves 1 and 93 are integrated together, not by branching of the supply line 15 and the tank line 16, but by branching of the pump passage 3 and the tank passage 4 inside the housings 2 and 94, the directional control valves 1 and 93 may be connected to the pump 91 in parallel with each other.

When the spool 6 is in its neutral position, the spool 6 blocks the supply/discharge passages 5A and 5B from the pump passage 3 and the tank passage 4. When the spool 6 shifts from the neutral position to one side or the other side, the spool 6 brings one of the supply/discharge passages 5A and 5B into communication with the pump passage 3, and brings the other one of the supply/discharge passages 5A and 5B into communication with the tank passage 4.

In the present embodiment, as shown in FIG. 2, a meter-in opening area between the pump passage 3 and one of the supply/discharge passages 5A and 5B increases to a maximum value β while the stroke of the spool 6 is increasing to a predetermined value α, and falls below the maximum value β when the stroke of the spool 6 exceeds the predetermined value α. What percentage of the maximum value β the meter-in opening area is to be at the full stroke of the spool 6 can be suitably set in accordance with the degree of priority of the hydraulic actuator 96 in relation to the hydraulic actuator 92 when moving the hydraulic actuators 92 and 96 concurrently.

Further, in the present embodiment, a meter-out opening area between the tank passage 4 and the other one of the supply/discharge passages 5A and 5B increases to a maximum value γ while the stroke of the spool 6 is increasing to the predetermined value α, and is kept to the maximum value γ when the stroke of the spool 6 exceeds the predetermined value α.

To be more specific, as shown in FIG. 3, the housing 2 includes: a central annular groove 21 located at the center of the spool hole 20 and recessed radially outward from the spool hole 20; and a pair of flow-in annular grooves 22 and 23 located at both sides of the central annular groove 21, respectively, and recessed radially outward from the spool hole 20. The pump passage 3 includes: a main passage forming the pump port 11; and branch passages 31 branched off from the main passage. The branch passages 31 are connected to the flow-in annular grooves 22 and 23, respectively.

The housing 2 further includes: a pair of middle annular grooves 24 and 25 located at the outer side of the flow-in annular grooves 22 and recessed radially outward from the spool hole 20; and a pair of flow-out annular grooves 26 and 27 located at the outer side of the middle annular grooves 24 and 25 and recessed radially outward from the spool hole 20.

The supply/discharge passages 5A and 5B are connected to the middle annular grooves 24 and 25, respectively. The tank passage 4 includes: a main passage forming the tank port 12; and branch passages 41 branched off from the main passage. The branch passages 41 are connected to the flow-out annular grooves 26 and 27, respectively.

On the other hand, the spool 6 includes: a central land 61, which is positioned between the flow-in annular grooves 22 and 23 when the spool 6 is in the neutral position; a pair of supply/discharge lands 64 and 65, which are positioned at both sides of the central land 61, respectively; and a pair of terminal lands 68 and 69, which are positioned at the outer side of the supply/discharge lands 64 and 65, respectively. The spool 6 further includes: a pair of inner smaller-diameter portions 62 and 63, which couple the central land 61 to the supply/discharge lands 64 and 65, respectively; and a pair of outer smaller-diameter portions 66 and 67, which couple the supply/discharge lands 64 and 65 to the terminal lands 68 and 69, respectively.

In the present embodiment, the central portion of the central land 61 includes an annular groove 61C, which divides the central land 61 into a first central land 61A and a second central land 61B. However, the central land 61 need not include the annular groove 61C, and the central land 61 may be a continuous land from one end to the other end thereof. When the spool 6 is in the neutral position, the supply/discharge lands 64 and 65 seal the middle annular grooves 24 and 25, respectively.

Annular passages 81 and 82 are located between the inner peripheral surface of the spool hole 20 and the inner smaller-diameter portions 62 and 63, respectively. Annular passages 83 and 84 are located between the inner peripheral surface of the spool hole 20 and the outer smaller-diameter portions 66 and 67, respectively.

The peripheral surface of the first central land 61A includes notches 71, which are open toward the annular passage 81, and the peripheral surface of the second central land 61B includes notches 72, which are open toward the annular passage 82. When the spool 6 is in the neutral position, the annular passage 81 overlaps the flow-in annular groove 22, and the annular passage 82 overlaps the flow-in annular groove 23.

The inner end portion of the peripheral surface of the supply/discharge land 64 includes notches 73, which are open toward the annular passage 81, and the outer end portion of the peripheral surface of the supply/discharge land 64 includes notches 75, which are open toward the annular passage 83. The annular passage 83 always overlaps the flow-out annular groove 26 regardless of the position of the spool 6.

Similarly, the inner end portion of the peripheral surface of the supply/discharge land 65 includes notches 74, which are open toward the annular passage 82, and the outer end portion of the peripheral surface of the supply/discharge land 65 includes notches 76, which are open toward the annular passage 84. The annular passage 84 always overlaps the flow-out annular groove 27 regardless of the position of the spool 6.

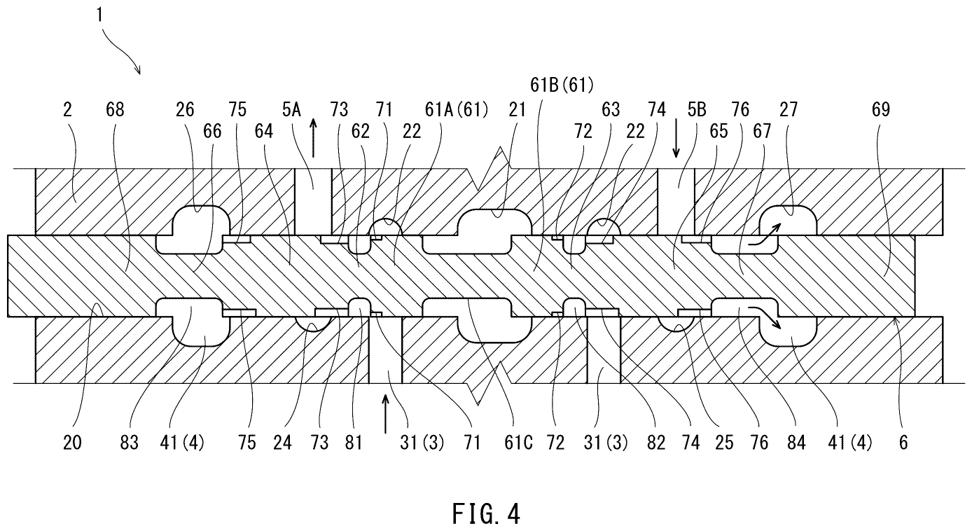

When the spool 6 shifts from the neutral position to one side (in FIG. 3, to the left), as shown in FIG. 4, the annular passage 81 comes into communication with the middle annular groove 24 via the notches 73, and the annular passage 84 comes into communication with the middle annular groove 25 via the notches 76. Consequently, the hydraulic liquid flows from one of the branch passages 31 of the pump passage 3 to the supply/discharge passage 5A through the flow-in annular groove 22, the annular passage 81, the notches 73, and the middle annular groove 24, and also, the hydraulic liquid flows from the supply/discharge passage 5B to one of the branch passages 41 of the tank passage 4 through the middle annular groove 25, the notches 76, the annular passage 84, and the flow-out annular groove 27.

On the meter-in side, from when the notches 73 and the middle annular groove 24 start communicating with each other until when the stroke of the spool 6 becomes the predetermined value α, the middle annular groove 24 and the annular passage 81 are always in communication with each other via the notches 73. Therefore, the maximum value β of the meter-in opening area is a total cross-sectional area of the notches 73 on a plane that is orthogonal to the axial direction of the spool 6.

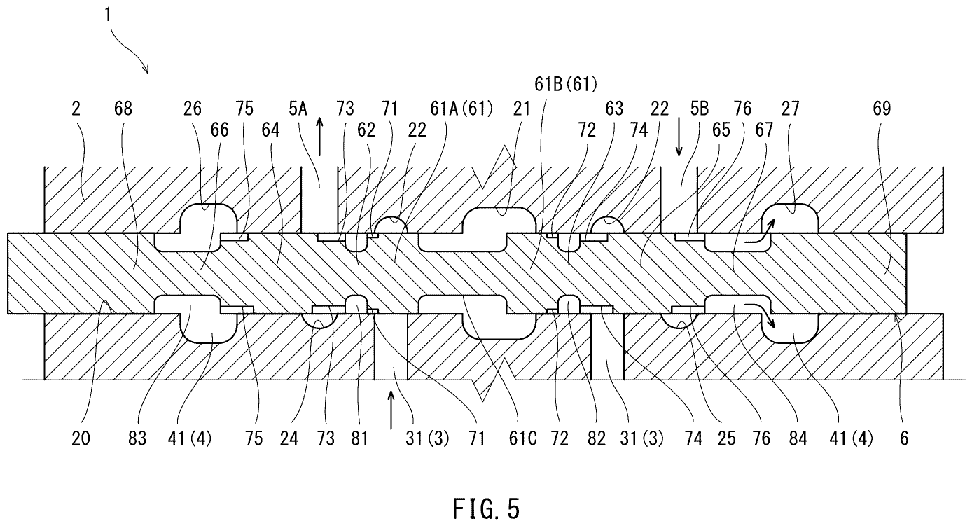

When the spool 6 further shifts and the stroke of the spool 6 exceeds the predetermined value α as shown in FIG. 5, the first central land 61A is located in a position where the first central land 61A covers the flow-in annular groove 22. Before the first central land 61A covers the flow-in annular groove 22, the flow-in annular groove 22 is in direct communication with the annular passage 81. On the other hand, when the first central land 61A is located in the position where the first central land 61A covers the flow-in annular groove 22, the flow-in annular groove 22 is in communication with the annular passage 81 through the notches 71. Consequently, the meter-in opening area decreases from the maximum value β to a total cross-sectional area of the notches 71 on a plane that is orthogonal to the axial direction of the spool 6.

On the meter-out side, from when the notches 76 and the middle annular groove 25 start communicating with each other until when the stroke of the spool 6 is maximized, the middle annular groove 25 and the annular passage 84 are always in communication with each other via the notches 76. Therefore, the maximum value γ of the meter-out opening area is a total cross-sectional area of the notches 76 on a plane that is orthogonal to the axial direction of the spool 6, and the meter-out opening area is kept to the maximum value γ until the stroke of the spool 6 is maximized from the predetermined value α or from a value less than the predetermined value α.

Actions performed when the spool 6 shifts from the neutral position to the other side (in FIG. 3, to the right) are the same as the above-described actions, except that the actions are performed in directions different from those of the above-described actions. Therefore, the description of the actions performed when the spool 6 shifts from the neutral position to the other side (in FIG. 3, to the right) is omitted herein.

As described above, according to the directional control valve 1 of the present embodiment, when a combined operation to move the hydraulic actuators 92 and 96 concurrently is performed, by making the stroke of the spool 6 of the directional control valve 1 greater than the predetermined value α, the amount of hydraulic liquid supplied to the hydraulic actuator 92 can be restricted. In addition, in the present embodiment, when restricting the amount of hydraulic liquid supplied to the hydraulic actuator 92, the meter-out opening area can be kept to the maximum value γ. In other words, the amount of f hydraulic liquid supplied to the hydraulic actuator 92 can be restricted without reducing the meter-out opening area.

For example, in a case where the hydraulic circuit is a hydraulic circuit of a construction machine such as a hydraulic excavator, the directional control valve 1 may be a slewing directional control valve for a slewing motor, and the directional control valve 93 may be a boom directional control valve for a boom cylinder. In this case, when a combined operation of a slewing operation and a boom raising operation is performed, by making the stroke of the spool of the directional control valve 1 greater than the predetermined value α, the supply of the hydraulic liquid to the boom cylinder is prioritized over the supply of the hydraulic liquid to the slewing motor, and thereby a sufficient boom raising speed can be secured.

### Variations

The present disclosure is not limited to the above-described embodiment. Various modifications can be made without departing from the scope of the present disclosure.

For example, when the stroke of the spool 6 exceeds the predetermined value α, the meter-out opening area of the directional control valve 1 may fall below the maximum value γ.

### Summary

The present disclosure provides a directional control valve including: a housing including a spool hole, a pump passage, a tank passage, and a pair of supply/discharge passages; and a spool that blocks the pair of supply/discharge passages from the pump passage and the tank passage when the spool is in its neutral position, and brings one of the pair of supply/discharge passages into communication with the pump passage and the other one of the pair of supply/discharge passages into communication with the tank passage when the spool shifts from the neutral position, the spool being received in the spool hole. An opening area between the pump passage and the one of the pair of supply/discharge passages increases to a maximum value while a stroke of the spool is increasing to a predetermined value, and falls below the maximum value when the stroke of the spool exceeds the predetermined value.

By connecting the above directional control valve to a pump in parallel with another directional control valve, and when a combined operation is performed, by making the stroke of the spool of the above directional control valve greater than the predetermined value, the amount of hydraulic liquid supplied to a particular hydraulic actuator corresponding to the above directional control valve can be restricted.

An opening area between the tank passage and the other one of the pair of supply/discharge passages may increase to a maximum value while the stroke of the spool is increasing to the predetermined value, and may be kept to the maximum value when the stroke of the spool exceeds the predetermined value. According to this configuration, when restricting the amount of hydraulic liquid supplied to a particular hydraulic actuator, the meter-out opening area can be kept to the maximum value.

For example, the housing may include: a pair of flow-in annular grooves recessed radially outward from the spool hole; a pair of middle annular grooves located at an outer side of the pair of flow-in annular grooves and recessed radially outward from the spool hole; and a pair of flow-out annular grooves located at an outer side of the pair of middle annular grooves and recessed radially outward from the spool hole. The pump passage may be connected to the pair of flow-in annular grooves. The pair of supply/discharge passages may be connected to the pair of middle annular grooves, respectively. The tank passage may be connected to the pair of flow-out annular grooves. The spool may include: a central land that is positioned between the pair of flow-in annular grooves when the spool is in the neutral position; a pair of supply/discharge lands that seal the pair of middle annular grooves, respectively, when the spool is in the neutral position; and a pair of smaller-diameter portions that couple the central land to the pair of supply/discharge lands, respectively. Annular passages may be located between an inner peripheral surface of the spool hole and the pair of smaller-diameter portions, respectively, and when the spool shifts from the neutral position, one of the annular passages comes into communication with a corresponding one of the middle annular grooves. When the stroke of the spool exceeds the predetermined value, the central land may be located in a position where the central land covers one of the pair of flow-in annular grooves, and the one of the pair of flow-in annular grooves may be in communication with a corresponding one of the annular passages through a notch in a peripheral surface of the central land.

### REFERENCE SIGNS LIST

1 directional control valve
2 housing
20 spool hole
22, 23 flow-in annular groove
24, 25 middle annular groove
26, 27 flow-out annular groove
3 pump passage
4 tank passage
5A, 5B supply/discharge passage
6 spool
61 central land
62, 63 inner smaller-diameter portion
64,65 supply/discharge land
66,67 outer smaller-diameter portion
68,69 terminal land
71 to 76 notch
81 to 84 annular passage

1. A directional control valve comprising:
a housing including a spool hole, a pump passage, a tank passage, and a pair of supply/discharge passages; and
a spool that blocks the pair of supply/discharge passages from the pump passage and the tank passage when the spool is in its neutral position, and brings one of the pair of supply/discharge passages into communication with the pump passage and the other one of the pair of supply/discharge passages into communication with the tank passage when the spool shifts from the neutral position, the spool being received in the spool hole, wherein
an opening area between the pump passage and the one of the pair of supply/discharge passages increases to a maximum value while a stroke of the spool is increasing to a predetermined value, and falls below the maximum value when the stroke of the spool exceeds the predetermined value.

2. The directional control valve according to claim 1, wherein
an opening area between the tank passage and the other one of the pair of supply/discharge passages increases to a maximum value while the stroke of the spool is increasing to the predetermined value, and is kept to the maximum value when the stroke of the spool exceeds the predetermined value.

3. The directional control valve according to claim 1, wherein
the housing includes:
a pair of flow-in annular grooves recessed radially outward from the spool hole;
a pair of middle annular grooves located at an outer side of the pair of flow-in annular grooves and recessed radially outward from the spool hole; and
a pair of flow-out annular grooves located at an outer side of the pair of middle annular grooves and recessed radially outward from the spool hole,
the pump passage is connected to the pair of flow-in annular grooves,
the pair of supply/discharge passages are connected to the pair of middle annular grooves, respectively,
the tank passage is connected to the pair of flow-out annular grooves,
the spool includes:
a central land that is positioned between the pair of flow-in annular grooves when the spool is in the neutral position;
a pair of supply/discharge lands that seal the pair of middle annular grooves, respectively, when the spool is in the neutral position; and
a pair of smaller-diameter portions that couple the central land to the pair of supply/discharge lands, respectively,
annular passages are located between an inner peripheral surface of the spool hole and the pair of smaller-diameter portions, respectively, and when the spool shifts from the neutral position, one of the annular passages comes into communication with a corresponding one of the middle annular grooves, and
when the stroke of the spool exceeds the predetermined value, the central land is located in a position where the central land covers one of the pair of flow-in annular grooves, and the one of the pair of flow-in annular grooves is in communication with a corresponding one of the annular passages through a notch in a peripheral surface of the central land.

4. The directional control valve according to claim 2, wherein
the housing includes:
a pair of flow-in annular grooves recessed radially outward from the spool hole;
a pair of middle annular grooves located at an outer side of the pair of flow-in annular grooves and recessed radially outward from the spool hole; and
a pair of flow-out annular grooves located at an outer side of the pair of middle annular grooves and recessed radially outward from the spool hole,
the pump passage is connected to the pair of flow-in annular grooves,
the pair of supply/discharge passages are connected to the pair of middle annular grooves, respectively,
the tank passage is connected to the pair of flow-out annular grooves,
the spool includes:
a central land that is positioned between the pair of flow-in annular grooves when the spool is in the neutral position;
a pair of supply/discharge lands that seal the pair of middle annular grooves, respectively, when the spool is in the neutral position; and
a pair of smaller-diameter portions that couple the central land to the pair of supply/discharge lands, respectively,
annular passages are located between an inner peripheral surface of the spool hole and the pair of smaller-diameter portions, respectively, and when the spool shifts from the neutral position, one of the annular passages comes into communication with a corresponding one of the middle annular grooves, and
when the stroke of the spool exceeds the predetermined value, the central land is located in a position where the central land covers one of the pair of flow-in annular grooves, and the one of the pair of flow-in annular grooves is in communication with a corresponding one of the annular passages through a notch in a peripheral surface of the central land.
